(19) United States
(12) Patent Application Publication
(10) Pub. No.: US 2007/0059470 A1
(43) Pub. Date: Mar. 15, 2007

(54) Adhesive tape and use thereof for bonding printing blankets

(75) Inventors: Marc Husemann, Hamburg (DE); Renke Bargmann, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 10/542,226

(22) PCT Filed: Dec. 17, 2003
(86) PCT No.: PCT/EP03/14396

§ 371 Date: Mar. 8, 2006

(30) Foreign Application Priority Data
Jan. 29, 2003 (DE) 103035397
Mar. 24, 2003 (DE) 103131213

(51) Int. Cl. B32B 37/12; B32B 38/14; B32B 37/26; B32B 33/00

(52) U.S. Cl. 428/40.1; 156/289; 156/277

(57) ABSTRACT

The adhesive tapes (20) for sticking together printing blankets on a metallic retaining bar or metal rail during a printing process. The adhesive tapes are composed of at least one layer (25), a release liner, and of a melt pressure-sensitive adhesive layer (30) that is applied to said release liner layer on one side. Both sides of the release line layer (25) have the same or different release.

The invention relates to the use of adhesive tapes for bonding printing blankets to a metallic retaining bar or metal rail during a printing process.

Within the printing industry a variety of methods are known for transferring designs by means of print originals to, for example, paper. One possibility consists in the technique known as flexographic printing. Another embodiment makes use of printing blankets, by means of which the printing ink is transferred to the paper. Printing blankets consist of a polymer material and a fabric support. For the printing process, the printing blankets are stretched around a cylinder. For this stretching operation a metallic retaining bar is located at each end of the printing blanket. This bar must on the one hand be bonded to the printing blanket, but in the course of use also becomes contaminated with solvent or water or printing ink. Consequently, exacting requirements are imposed on the retaining bars, since high stretching forces are also applied.

For the fixing of the retaining bar there exists a variety of possibilities. In the simplest case the bar is bonded to the printing blanket using a liquid adhesive. This process has already been employed for a long time, but possesses drawbacks such as slow operating or high residue solvent fraction requiring evaporation.

A further, very preferred possibility is the use of pressure-sensitive hotmelt adhesives. U.S. Pat. No. 5,487,339 describes the use of pressure-sensitive hotmelt adhesives for bonding printing blankets. There, for example, the pressure-sensitive hotmelt adhesives cited include nylon or polyurethane-based adhesives, which are suitable for this utility.

For operating, however, a number of additional requirements are imposed on the pressure-sensitive adhesive tape. First, it is not possible to use a straight pressure-sensitive hotmelt adhesive film for operating, since in the course of the laminating operation the pressure-sensitive hotmelt adhesive would stick to the laminating roll or to the laminating carriage. There is therefore a need for an operating aid, this aid having to be temperature-resistant even at temperatures of 200° C. and having to have a defined release force even after temperature exposure and also under temperature.

Moreover, the adhesive composition must meet specific requirements: that is, for example., a high resistance to solvents or water. Furthermore, there must be effective adhesion to aluminum, steel, and the fiber material of the printing blanket.

There is therefore a need for an adhesive tape which meets the requirements specified above.

Surprisingly, and unforeseeably for the skilled worker, this object is achieved by means of the adhesive tapes of the invention having the features specified in claim 1. The tape in question is a transfer tape consisting of a copolyamide adhesive and a release liner which possesses a release force of between 0.5 and 3 cN/cm at RT and a release force of 1 to 10 cN/cm after lamination at 220° C. The release forces are measured in accordance with test methods A and B.

The pressure-sensitive hotmelt adhesive of the adhesive tapes is a copolyamide. The pressure-sensitive hotmelt adhesive layer has a thickness of at least 100 μm, preferably between about 120 and about 250 μm, more preferably between about 150 and about 200 μm. The softening point of the copolyamide is between about 90° C. and about 160° C., in particular between about 100° C. and about 160°0 C.

The copolyamide used is free from tack. The release liner used is temperature-stable up to at least 200° C., preferably up to at least 220° C. More preferably the release liner has a weight of between about 80 g/m² and about 200 g/m² and a thickness of between about 70 μm and about 150 μm.

In one embodiment the release liner of the adhesive tape comprises a backing material furnished on both sides with a release liner layer, the material of the release layer being based on silicone or fluorinated compounds, and being in particular a polydimethylsiloxane.

One side of the backing material may have a release layer with higher release than the release layer on the other side.

The two release layers may, with different release, have been provided with a different material application rate. It is also possible in this context for the two release layers with different release to have different chemical compositions.

The release layer joined to the pressure-sensitive hotmelt adhesive layer has a release force (release) of preferably between about 0.5 and 3 cN/cm at room temperature and a release force of about 1 to 10 cN/cm following lamination at about 220° C.

The backing material used is, for example, release paper. The backing material may be a polymer backing, composed in particular of polyimide, polyethylene naphthylate or polyethylene terephthalate. The layer thickness of the backing material is between about 6 and about 100 μm, in particular between about 12 and about 50 μm.

Depending on the nature of the backing material, the release layers have a material application rate of at least about 0.8 g/m² (backing material=release paper), or at least 0.5 g/m² (backing material=polymer backing), preferably 1.0 g/m².

The invention further relates to the use of the adhesive tapes of one of claims 1 to 19 for bonding a printing blanket to a metallic retaining bar during a printing process.

The invention further provides a method of applying inventively designed adhesive tapes to a printing blanket, using a laminating apparatus, with the following worksteps:
a) introducing heat via the laminating apparatus and the release liner into the pressure-sensitive hotmelt adhesive layer,
b) exerting pressure on the adhesive tape via the laminating apparatus, the adhesive tape being pressed with its pressure-sensitive hotmelt adhesive layer onto the fabric side of the printing blanket,
c) guiding the laminating apparatus along the edge of the printing blanket, at the same time unwinding the adhesive tape.

The laminating apparatus here is a laminating roller or a laminating carriage in order to introduce the heat the laminating apparatus is heated, with heating taking place preferably to at least 180° C. The laminating speed ought in this case to amount to between about 1 and about 20 m/min.

The drawings serve to illustrate the invention hereinbelow. In vertical sectional representations

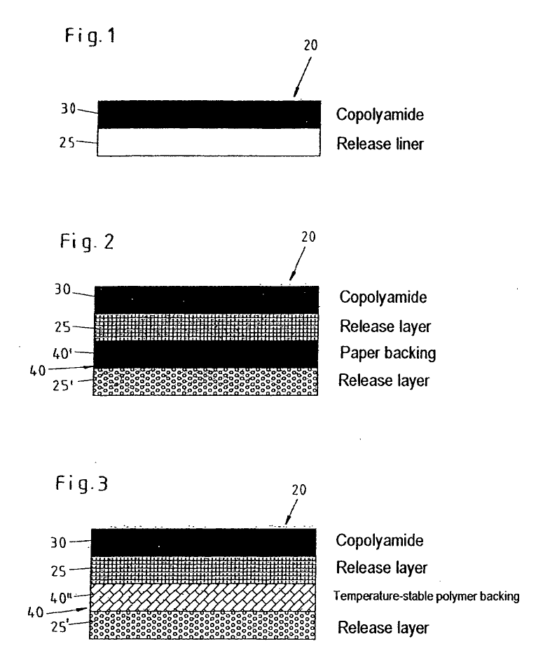

FIG. 1 shows an adhesive tape with a release liner, with a single-slidedly applied pressure-sensitive hotmelt adhesive layer composed of a copolyamide,

FIG. 2 shows a further embodiment of an adhesive tape having a backing material composed of a release paper, with layers of a release liner applied to both sides of the release paper, a pressure-sensitive hotmelt adhesive layer being applied to one of the two release liner layers,

FIG. 3 shows a further embodiment of an adhesive tape, comprising a temperature-stable polymer backing, with layers of a release liner applied to both sides of the polymer backing, a pressure-sensitive hotmelt adhesive layer being applied to one of the two release liner layers,

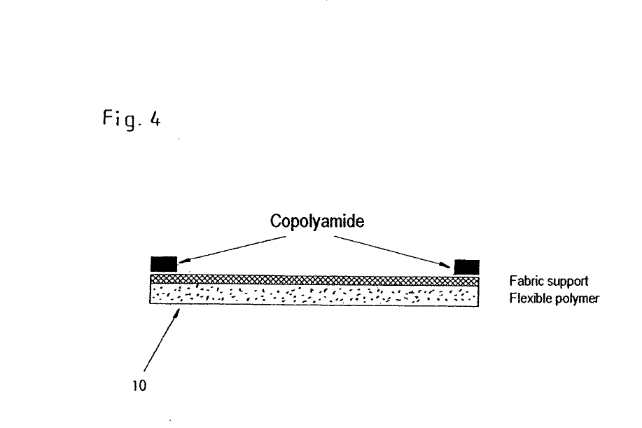

FIG. 4 shows a printing blanket with the adhesive tape to be applied,

FIG. 5 shows the printing blanket with applied copolyamide film and metal rail end before initiation of the hot pressing process, and

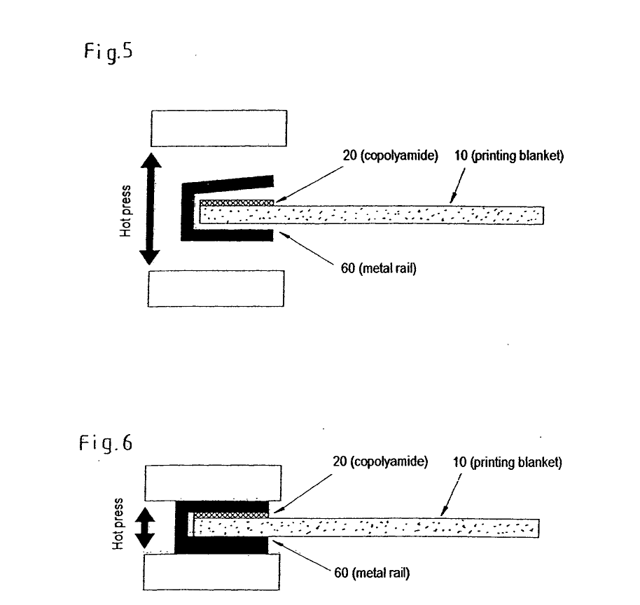

FIG. 6 shows the printing blanket with applied copolyamide film and metal rail end after hot compression.

In FIGS. 1 to 6 a printing blanket is identified by 10 and an adhesive tape by 20. In the embodiment of FIG. 1 the adhesive tape 20 is composed of two layers, namely the release liner layer 25 and a pressure-sensitive hotmelt adhesive layer 30 which is applied to said layer 25 and is composed of a copolyamide.

The copolyamide is distinguished by the fact that it possesses at least a layer thickness of more than 100 μm and a tensile strength which is significantly increased as compared with EVA or polyolefins.

According to one preferred embodiment the maximum layer thickness of the copolyamide is between 120 and 250 μm, and in a very preferred version of the invention it is between 150 and 200 μm.

For application as a heat-activable sheet, the softening range of the copolyamide is essential. In one preferred embodiment of the invention the softening point of the copolyamide is above 90° C., and in a more-preferred version it is above 100° C. The maximum softening temperature is ≦160° C.

In addition the copolyamide ought to have no tack, since tack would disrupt the operation of lamination to the printing blanket.

The copolyamides required for the adhesive tape 20 are available commercially and are supplied commercially, for example, under the trade name Platamid™ by the company Elf-Atochem or under the trade name Griltex™ by EMS-Chemie.

A further constituent of the adhesive tape 20 is at least one release liner (FIG. 1). The release liner is required to fulfill a variety of functions, such as, for example, imparting mechanical stability to the pressure-sensitive hotmelt adhesive, so that pressure-sensitive hotmelt adhesive can be handled reliably in the laminating operation and can be applied cleanly to the end of the printing blanket. Furthermore, the release layer must also have a high temperature stability, since often more than 220° C. are employed for laminating the pressure-sensitive hotmelt adhesive. As a further function, the release liner must possess a controlled release force, since on the one hand the adhesive tape 20 must be able to be unwound and on the other hand the adhesive film even at high temperatures must be capable of being removed cleanly and without picks or residues from, for example, a glassine liner. According to one preferred embodiment, therefore, a glassine liner with a weight of at least 80 g/m² and a thickness of at least 70 μm is used. The maximum weight is 200 g/m² and the maximum thickness 150 μm. For the release force a release paper 40′ is equipped as backing material 40 on both sides with a release liner layer 25, 25′, this layer being based preferably on silicone or fluorinated compounds. According to another very preferred embodiment, polydimethylsiloxane is used as release agent. The release paper 40 possesses a controlled release; that is, the two sides differ in their release force (FIG. 2). Accordingly the adhesive tape 20 is composed of the release paper 40′. Applied to both sides of the release paper 40′ is a layer 25 and 25′, respectively, of a release liner. Applied to the layer 25 of the release liner is the pressure-sensitive hotmelt adhesive layer 30 comprising the copolyamide.

For the adhesive tape 20 of the invention it is necessary, therefore, that the release liner layer 25′ possesses a higher release than the release liner layer 25. In order to achieve these properties, the release liner layer 25 may differ from the release liner layer 25′ not only in chemical composition but also in material application rate. The minimum material application rate of the release liner layers 25, 25′ is a function of the surface roughness of the paper. If the release liner layer is too thin, the paper is not fully masked and, when the copolyamide detaches—particularly under heat—instances of paper-fiber extraction occur, and adversely affect the bonding of the printing blanket 10. Consequently the material application rate of the release liner layer 25 and 25′ is at least 0.8 g/m², more preferably 1.0 g/m². At the upper end there are in theory no limits, but at material application rates of more than 3.0 g/m² there are frequently difficulties with complete through-volume curing of the release liner layers 25, 25′, so that silicone may be transferred to the bond. Particularly as regards the bonding of the printing blanket 10 to steel bars or aluminum bars, even small amounts of silicone would massively disrupt the bond. Where the release liner layers 25 and 25′ differ in their composition, the material application rate of the release liner layers 25 and 25′ may indeed be the same. For the inventive use of the adhesive tape 30 for bonding printing blankets 10, furthermore, the exact release force of the release liner layer 25 to the copolyamide is a necessity.

According to one preferred embodiment of this invention the release liner layer 25 is damaged with a corona prior to coating. The applied corona energy is preferably between 20 and 70 Wmin/m².

Preferably the release liner layer 25 of the siliconized glassine paper possesses a release force of between 0.5 and 3 cN/cm at RT and possesses a release force of 1 to 10 cN/cm after lamination at 220° C. The release forces are determined in accordance with test methods A and B.

Glassine liners are available commercially through the companies Laufenberg, Rexam or Loparex.

According to a further embodiment, release liners with a polymer backing 50 are used. For the use of the adhesive tape 20, however, it is absolutely necessary for the polymer backing 40″, as backing material 40, to withstand, for short intervals, temperatures of 200° C. or even 220° C. with dimensional stability. For this purpose it is possible to use all of the materials that are known to the skilled worker. Preference is given as polymer materials to using polyimide, polyethylene naphthylate (PEN) or polyethylene terephthalate (PET).

The construction of the adhesive tape 20 is depicted in FIG. 3 in accordance with a further embodiment. According to this the construction of the adhesive tape 20 is such that the temperature-stable polymer backing 40″ has release liner layers 25, 25′ on both sides, the hotmelt adhesive layer 11 comprising the copolymer being applied on the release liner layer 25.

The polymer backing 40″ must in turn exhibit a stabilizing function for the copolyamide. The layer thickness of the polymer backing 40″ is between 6 μm and 100 μm, more preferably between 12 μm and 50 μm.

The material application rate of the release liner layer 25 and 25′ is at least 0.5 g/m², more preferably 1.0 g/m². At the upper end there are in theory no limits, but again, at material application rates of more than 3.0 g/m², difficulties occur with silicone transfer.

Processes for Producing the Adhesive Tape

The copolyamide is coated onto the glassine liner via a melt die or via an extrusion die or via a roll applicator. For processing for this purpose, heat is introduced and the copolyamide is warmed preferably up to at least the corresponding softening point. According to one preferred embodiment the copolyamide is coated via a melt die or an extrusion die. In the case of melt-die coating it is possible to employ the contact method or the contactless method. In order to achieve a uniform coating pattern, temperatures of at least 170° C. are generally required for coating.

In the process in connection with extrusion-die coating the copolyamide is coated through an extrusion die. The extrusion dies used may originate advantageously from one of the following three categories: T dies, fishtail dies, and coathanger dies. The individual types differ in the design of their flow channel.

For the purpose of coating, it is particularly preferred to carry out coating onto the release liner using a coathanger die, specifically in such a way that a movement of die relative to backing produces a polymer layer on the backing. Generally speaking the die gap of the extrusion die is greater than the target layer thickness of the copolyamide. For the purpose of transferring the copolyamide to the release liner without air bubbles, a variety of processes can be employed for extrusion coating. The copolyamide can be pressed against the liner via an air knife; it can be drawn onto the liner under suction via a vacuum box; or it can be placed on via electrostatic charging. For the operation of producing the adhesive tape it may additionally be necessary for the release liner to be treated prior to coating, by means, for example, of a corona or a flame pretreatment, in order to set the desired release forces.

Use of the Adhesive Tape

The adhesive tape 20 is used for bonding printing blankets 10 to aluminum or steel bars or other metal bars or rails 60. In a first step the adhesive tape 20 is laminated to the fabric side of the printing blanket 10. Securing takes place at the ends of the printing blanket 10 (FIG. 4). The width of the two copolyamide strips is generally between 9 mm and 30 mm. For the laminating operation the adhesive tape 20 is unwound and is guided with the copolyamide side downward to the upper fabric side of the printing blanket 10. For contacting, heat is introduced via a laminating roller or a carriage. For this purpose, in the simplest case, the laminating roller or the laminating carriage is heated. According to one preferred embodiment the temperature of the laminating roller or carriage is at least 180° C. The temperature is introduced through the release liner into the copolyamide, which then begins to melt and to develop tack. In order to increase the bond strength, pressure is additionally exerted via the laminating roller or carriage. The pressure, in turn, is transferred via the release paper and the copolyamide film is pressed onto the fabric support of the printing blanket 10. The laminating roller or laminating carriage is mobile and runs along the edge of the printing blanket 10 with simultaneous unwinding of the adhesive tape 20. By way of this movement, the entire edge of the printing blanket 10 is provided with the copolyamide film. The laminating speed is preferably between 1 m/min and 20 m/min. For the adhesive tape 20 the release function of the release liner is critical, since here, even under hot conditions, the release force must be higher than that of the fabric support, since otherwise, after the laminating operation and the winding of the release liner, in turn, this material would remain on the release liner and hence the copolyamide would be pulled again from the fabric support. Another important aspect is the bond strength of the copolyamide to the fabric support. In particular the copolyamide, at temperatures above the softening range, has a high bond strength—even in comparison with other hotmelt adhesives. After the operation of laminating the copolyamide onto the printing blanket 10, the printing blanket is clamped into an aluminum or steel or other metal rail. The operation is described precisely in U.S. Pat. No. 5,487,339.

FIG. 5 shows how the printing blanket with copolyamide film and metal rail end is inserted into the hot press. The metal rail 60 is compressed under the pressure and introduction of heat by the press (FIG. 6). The temperature in this step—depending on the copolyamide—is between 200 and 250° C. The pressing operation ought to be performed for at least 10 seconds, more preferably for 30 seconds. At the upper end there are no limits, although the efficient operating speed is below one minute.

The advantages of the adhesive tape of the invention are described below in a number of experiments.

Experiments

The adhesive tapes of the invention are described below by means of experiments.

The following test methods were employed in order to evaluate the technical properties of the pressure-sensitive adhesives prepared.

Test Methods

180° Peel Strength (Test A)

A strip 20 mm wide of a copolyamide applied with a layer thickness of 150 μm is peeled from the release liner at 180° using a Zwick tensile testing machine. The measurement results are reported in cN/cm and have been averaged from three measurements. All measurements were conducted at room temperature under climatized conditions. The peel rate is 300 mm/min.

180° Release Liner Peel Strength (Test B)

A test strip 20 mm wide and about 500 mm long of an adhesive tape is laminated by the hotmelt adhesive side to a grease-free steel plate at 200° C. and a speed of 5 m/min with an applied pressure of 20 N. Immediately thereafter the release liner is peeled from the hotmelt adhesive at an angle of 180° using a Zwick tensile testing machine. The peel rate is 300 mm/min. The measurement results are reported in cN/cm and have been averaged from three measurements.

Solvent Resistance (Test C)

The bond of a strip, 5 cm wide, of a printing blanket, bonded to an aluminum profile, is immersed in a solvent at room temperature for 24 hours. Subsequently the assembly is dried and the aluminum profile is peeled off at 500 mm/min in a tensile testing machine from Zwick. The test is passed if the printing blanket tears.

### Reference Example 1

In a SIG single-screw extruder the copolyamide Griltex™ D 1500 (EMS-Chemie) is coated with a die temperature of 180° C. onto a release paper bearing a 1.5 g/m² PE coating. The layer thickness of the hotmelt adhesive was 150 μm. The copolyamide film was pressed against the release paper by electrostatic charging. The temperature of the coating roll was 23° C.

### Reference Example 2

In a SIG single-screw extruder the copolyamide Griltex™ D 1500 (EMS-Chemie) is coated with a die temperature of 180° C. onto a release paper bearing a 0.5 g/m² polydimethylsiloxane coating. The layer thickness of the hotmelt adhesive was 150 82 m. The copolyamide film was pressed against the release paper by electrostatic charging. The temperature of the coating roll was 23° C.

### Reference Example 3

In a SIG single-screw extruder the low-density polyethylene (Lacqtene™ FE 8000, Elf Atofina) is coated with a die temperature of 160° C. onto a release paper bearing a 1.6 g/m² polydimethylsiloxane coating. The layer thickness of the hotmelt adhesive was 150 μm. The PE film was pressed against the release paper by electrostatic charging. The temperature of the coating roll was 23° C.

### EXAMPLE 4

In a SIG single-screw extruder the copolyamide Griltex™ D 1500 (EMS-Chemie) is coated with a die temperature of 180° C. onto a release paper bearing a 1.5 g/m² polydimethylsiloxane coating and corona-pretreated at 40 Wmin/m² (400 W 20 m/min belt speed). The layer thickness of the hotmelt adhesive was 150 μm. The copolyamide film was pressed against the release paper by electrostatic charging. The temperature of the coating roll was 23° C.

### EXAMPLE 5

In a SIG single-screw extruder the copolyamide Griltex™ D 1500 (EMS-Chemie) is coated with a die temperature of 180° C. onto a release paper bearing a 1.5 g/m² polydimethylsiloxane coating and corona-pretreated at 40 Wmin/m² (400 W 20 m/min belt speed). The layer thickness of the hotmelt adhesive was 180 μm. The copolyamide film was pressed against the release paper by electrostatic charging. The temperature of the coating roll was 23° C.

Bonding to Printing Blanket

A printing blanket 50 cm wide, from Reeves Brothers, is laminated along its edge on the fabric side with an adhesive strip, 15 mm wide, from examples 1 to 5, in analogy to test method B. For the reference examples 1 and 2 the release liner was removed slowly under cold conditions. In the case of examples 3 to 5 the release liner was peeled off immediately and the printing blanket with adhesive strip was inserted into an aluminum profile from Reeves Brothers. The adhesive film is located on the upwardly arched side of the aluminum profile. Subsequently, using a hot press from Bürkle, the top, upwardly arched side of the aluminum profile is pressed downward onto the adhesive film. The press operation takes place at 220° C. and runs for 60 seconds. It is followed by cooling to room temperature.

Results:

To investigate the various adhesive tapes, 5 different examples were produced. Examples 1 to 3 are reference examples, while examples 4 and 5 correspond to the inventive main claim.

In reference examples 1 and 2, different release liners with a copolyamide adhesive were used; in reference example 3, a polyolefin was used as thermoplastic polymer.

In the first experiments, in accordance with test A and B, the 180° peel strength and the 180° release liner peel strength were determined for all 5 examples. The values found by measurement are listed in table 1.

TABLE 1

| | | Test B |
|---|---|---|
| | | 180° release |
| | Test A | liner peel |
| | peel strength | strength in |
| | in cN/cm | cN/cm |
| Reference example 1 | 30.5^{a} | —^{b} |
| Reference example 2 | —^{b} | —^{b} |
| Reference example 3 | 1.5 | 3.0 |
| Example 4 | 1.7 | 6.3 |
| Example 5 | 2.0 | 7.5 |

^{a}release liner undergoes partial splitting
^{b}release liner undergoes splitting

Table 1 illustrates the fact that examples 4 and 5 lend themselves well to lamination and application. Furthermore, reference example 3 likewise meets the application conditions. Reference examples 1 and 2 cannot be laminated.

In table 2, printing-blanket bonds were investigated, particularly under the influence of solvent.

TABLE 2

| | Test C | | |
|---|---|---|---|
| | special- | | |
| | boiling-point | Test C | Test C |
| | spirit | water | ethanol |
| Reference example 1 | pass | pass | pass |
| Reference example 2 | pass | pass | pass |
| Reference example 3 | fail | fail | fail |
| Example 4 | pass | pass | pass |
| Example 5 | pass | pass | pass |

From table 2 it is apparent that the inventive examples 4 and 5 pass the test well. Reference examples 1 and 2 as well pass the test, and illustrate the fact that copolyamides are very suitable for bonding printing blankets. Only reference example 3, which is based on a polyolefin hotmelt adhesive, shows that not all thermoplastics are suitable for bonding printing blankets.

1. An adhesive tape, comprising a release liner having two sides and a pressure-sensitive hotmelt adhesive layer applied to one side of the release liner, the two sides of the release liner layer exhibiting the same or different release.

2. The adhesive tape of claim 1, wherein the pressure-sensitive hotmelt adhesive is a copolyamide.

3. The adhesive tape of claim 1, wherein the pressure-sensitive hotmelt adhesive layer has a thickness of at least 100 μm.

4. The adhesive tape of claim 2, wherein the copolyamide has a softening point between about 90° C. and about 160° C.

5. The adhesive tape claim 2, wherein the copolyamide is free from tack.

6. The adhesive tape of claim 1 wherein the release liner is temperature-stable up to at least 200° C.

7. The adhesive tape of claim 1, wherein the release liner has a weight of between about 80 g/m² and about 200 g/m².

8. The adhesive tape of claim 1, wherein the release liner layer has a thickness of between about 70 μm and about 150 μm.

9. The adhesive tape of claim 1, wherein the release liner comprises a backing material furnished on both sides with a release liner layer.

10. The adhesive tape of claim 9, wherein the backing material of the release liner layer is based on silicone or fluorinated compounds.

11. The adhesive tape of claim 9, wherein one side of the backing material has a release liner layer with higher release than a release liner layer on the other side.

12. The adhesive tape of claim 11, wherein the two release liner layers with different release have a different material application rate.

13. The adhesive tape of claim 11, wherein the two release liner layers with different release have different chemical compositions.

14. The adhesive tape of claim 9, wherein the release liner layer joined to the pressure-sensitive hotmelt adhesive layer has been pretreated.

15. The adhesive tape of claim 9, wherein the release liner layer joined to the pressure-sensitive hotmelt adhesive layer has a release force (i.e., release) of between about 0.5 and 3 cN/cm at room temperature and a release force of about 1 to 10 cN/cm following lamination at about 220° C.

16. The adhesive tape of claim 9, wherein the backing material is a release paper.

17. The adhesive tape of claim 9, wherein the backing material is a polymer backing.

18. The adhesive tape of claim 17, wherein the backing material has a layer thickness of between about 6 and about 100 μm.

19. The adhesive tape of claim 9, wherein the release liner layers, depending on the nature of the backing material, have a material application rate of at least about 0.8 g/m² (backing material=release paper), or at least 0.5 g/m² (backing material=polymer backing).

20. A method of producing the adhesive tape of claim 1, comprising coating the pressure-sensitive hotmelt adhesive onto a corona-pretreated release paper by extrusion coating, with no air bubbles.

21. A method comprising bonding a printing blanket to a metallic retaining bar with an adhesive tape of claim 1 during a printing process.

22. A method of applying and of bonding adhesive tapes of an adhesive tape of claim 1 to a printing blanket using a laminating apparatus, comprising the following steps:
a) introducing heat via the laminating apparatus and the release liner into the pressure-sensitive hotmelt adhesive layer,
b) exerting pressure on the adhesive tape via the laminating apparatus, the adhesive tape being pressed with its pressure-sensitive hotmelt adhesive layer onto the fabric side of the printing blanket,
c) guiding the laminating apparatus along the edge of the printing blanket, at the same time unwinding the adhesive tape.

23. The method of claim 22, wherein the laminating apparatus is a laminating roller or a laminating carriage.

24. The method of claim 22, wherein heat is introduced by heating the laminating apparatus.

25. The method of claim 24, wherein the laminating apparatus is heated to at least 180° C.

26. The method of claim 22, wherein the laminating speed is between about 1 and about 20 m/min.
